(19) United States
(12) Patent Application Publication
(10) Pub. No.: US 2009/0282942 A1
(43) Pub. Date: Nov. 19, 2009

(54) PUSH-BUTTON SWITCH WITH TACTILE FEEDBACK

(76) Inventor: Thomas H. Wilson, Indianapolis, IN (US)

Correspondence Address: ALLISON TRANSMISSION, INC., BARNES & THORNBURG LLP, 11 SOUTH MERIDIAN STREET, INDIANAPOLIS, IN, 46204, US

(21) Appl. No.: 12/402,189

(22) Filed: Mar. 11, 2009

Related U.S. Application Data
(60) Provisional application No. 61/037,933, filed on Mar. 19, 2008.

(51) Int. Cl. F16H 59/04

(52) U.S. Cl. 74/473.3

(57) ABSTRACT

A user interface for an automatic transmission includes a base surface, a display configured to display the operational status of the automatic transmission, and a selector. The selector includes a selector surface spaced apart from the base surface, a boundary surface coupled to the selector surface and coupled to the base surface. The boundary surface is shaped such that the boundary surface and the selector surface cooperate to define a plurality of interconnected selector inputs. The selector inputs are independently actuable and each is operative to provide a specific input to the automatic transmission and configured such that a user may tactilely distinguish the first selector and each of the plurality first selector inputs.

This application claims the benefit, under 35 U.S.C. § 119(e), of U.S. Provisional Patent Application Ser. No. 61/037,933 filed Mar. 19, 2008 which is hereby incorporated by reference herein in its entirety.

### BACKGROUND OF THE INVENTION

The present disclosure is directed to a user interface for an automatic transmission. More specifically, the present disclosure is directed to a user interface for an automatic transmission which is configured with functional parameter selectors configured such that a user may tactilely distinguish each selector apart from each other selector and such that a user my distinguish each of the plurality of selector inputs associated with the selector from each other selector input associated with the selector.

The use of selector levers as shifters in both automatic and manual transmissions is known. In the case of manual transmissions, a user develops a skill for determining the status of the transmission input by the position of the selector lever. In a traditional automatic transmission, a selector lever is positioned to place the transmission in a selected operating status with a visual indicator. In the case of modem automatic transmissions for vehicles, the automatic transmission may be shifted by actuating an input which sends a signal to a transmission controller. The controller then adjusts the transmission electrically and provides the feedback of transmission status to a display.

### SUMMARY OF THE INVENTION

This application discloses one or more of the features recited in the appended claims and/or the following features which, alone or in any combination, may comprise patentable subject matter:

A user interface for an automatic transmission comprises a base surface, a display configured to display the operational status of the automatic transmission, a first selector and a second selector. Illustratively, the first and second selectors include a selector surface separated from the base surface by a boundary surface coupled to the selector surface and coupled to the base surface. The boundary surface is shaped such that the boundary surface and the selector surface cooperate to define a plurality of interconnected selector inputs. Each of the plurality of selector inputs is operative to provide a specific input to the automatic transmission. The selectors are configured such that a user may tactilely distinguish each selector apart from each other selector. The selectors are also configured such that a user may distinguish each of the plurality of selector inputs associated with the selector from each other selector input associated with the selector.

One of the first and second selectors may include a selector input operable to place the transmission in a reverse mode. One of the first and second selectors may include a selector input operable to place the transmission in a neutral mode and may include yet another selector input operable to place the transmission in a drive mode. Also, one of the first and second selectors may include a selector input operable to increase a selected operational parameter of the transmission. Still yet, one of the first and second selectors may include a selector input operable to decrease a selected operational parameter of the transmission.

The user interface may further include a third selector having a selector surface separated from the base surface by a boundary surface coupled to the third selector surface and coupled to the base surface. The boundary surface may be shaped such that the boundary surface and the third selector surface cooperate to define a selector input operative to provide a specific input to the automatic transmission. The third selector may be configured such that a user may tactilely distinguish the third selector and the selector input associated with the third selector.

Each of the selector inputs may be configured to provide a tactile feedback to the user that the selector input has been actuated. Illustratively, the selector inputs may each comprise a discrete momentary switch. The boundary surface of the selectors may extend outwardly away from the base surface or extend inwardly from the base surface.

Illustratively, the boundary surface of the selectors may be shaped to define a generally circular shape for each selector input, the generally circular shapes interconnected to form a unitary input surface. When the boundary surface extends inwardly from the base surface, the boundary surface may cooperate with the selector surface of the respective first, second and third selector to form a well in which the selector inputs are positioned. When the boundary surface extends outwardly from the base surface, the boundary surface may cooperate with the selector surface of the respective first, second and third selector to form an island extending upwardly from the base surface.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a diagrammatic representation of a vehicle including a user interface positioned near a driver seat of the truck and communicating with a controller of a transmission of the vehicle;

FIG. 2 is top view of the user interface of FIG. 1, the user interface including a number of selectors having selector inputs,

FIG. 3 is a cross-sectional view of a selector input of the user interface of FIG. 2, the cross-section taken along lines 3-3 in FIG. 2; and

FIG. 4 is a cross-sectional view similar to FIG. 3, FIG. 4 showing another embodiment of selector input.

### DETAILED DESCRIPTION OF THE DRAWINGS

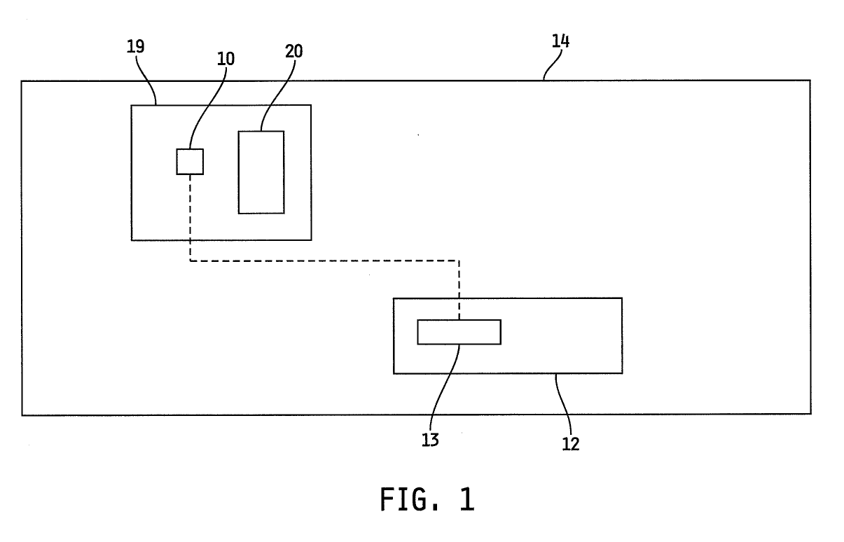

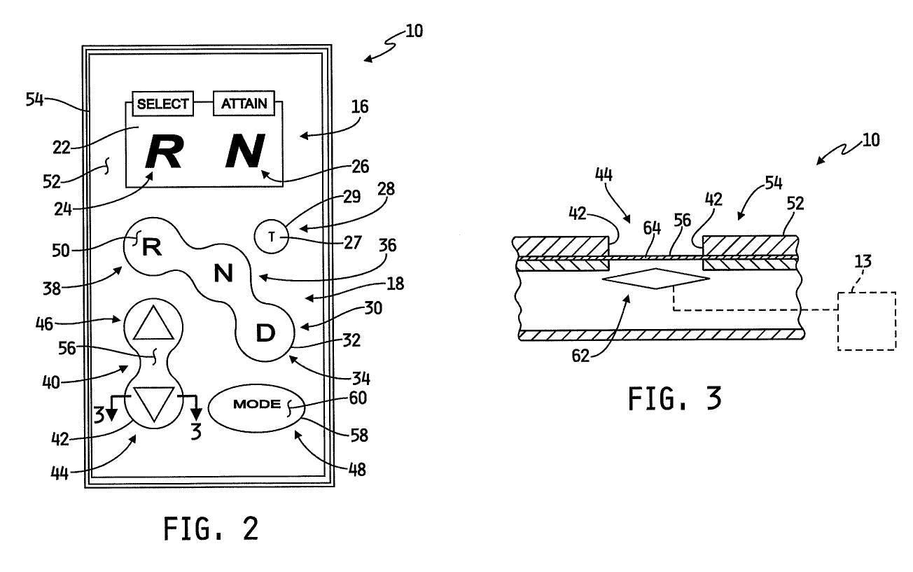

A user interface 10 for an automatic transmission 12 of a vehicle 14 is positioned near a driver seat 20 in the cab 19 of the vehicle 14 as shown diagrammatically in FIG. 1 and communicates with a controller 13 of the transmission 12. The user interface 10 includes a display 16 and a user input panel 18 as shown in FIG. 2. In the illustrative embodiment shown in FIG. 2, the display 16 includes a liquid crystal display (LCD) 22 that is configured to display status conditions of the automatic transmission 12. The LCD 22 is partitioned into a first portion 24 and a second portion 26. The first portion 24 is configured to display at least one alphanumeric character that is representative of an operational status of the transmission 12. The second portion 26 is also configured to display at least one alphanumeric character that is representative of an operational status of the transmission 12. In some embodiments, the first portion 24 and the second portion 26 may be independent segmented displays. For example, both the first portion 24 and second portion 26 may each comprise a segmented vacuum fluorescent display or a segmented light emitting diode (LED) display. Illustratively, the first portion 24 is operable to display an attainable attribute, such as a maximum attainable range or gear, for example, of the transmission 12 in the currently selected mode. Further illustratively, the second portion 26 is operable to display a status of the transmission 12 such as the current attained range or gear the transmission 12 has engaged. Further, display 16 is operable to display error codes or diagnostic codes associated with the transmission 12.

User interface 10 further includes a first selector illustratively embodied as a segmented input 30. Segmented input 30 includes a boundary surface 32 circumscribing a perimeter of the segmented input 30. Boundary surface 32 is shaped to form three selector input portions 34, 36 and 38. Segmented input 30 further includes a selector surface 50 separated from a base surface 52 of a panel 54 of user interface 10 via the boundary surface 32. Boundary surface 32 is formed such that each of the selector input portions 34, 36 and 38 are interconnected with a common surface 50. However, each of the selector input portions 34, 36 and 38 are distinguished form each other by generally circular shapes of the boundary surface 32 that at least partially surround each of the input portions 34, 36 and 38.

The shape and orientation of the segmented input 30 provides a tactile indication of the positions of the various input portions 34, 36 and 38 relative to other inputs of the user interface 10. In the illustrative embodiment input portion 34 operates as a selector of a drive mode of transmission 12. Similarly, input portion 36 is illustratively embodied as a selector of a neutral mode of the transmission 12. In the illustrative embodiment, input portion 38 is a selector of a reverse mode of the transmission 12. Each of the input portions 34, 36 and 38 are independently actuable relative to the other of the user input portions 34, 36 and 38.

User interface 10 further includes a second selector embodied as segmented input 40 having a boundary surface 42 which circumscribes a perimeter of segmented input 40 to define two user input portions 44 and 46. Segmented input 40 further includes a selector surface 56 separated from surface 52 of panel 54 by boundary surface 42. In the illustrative embodiment, user input portion 44 corresponds to a down arrow input such as that used to reduce or lower a selected value. Similarly, in the illustrative embodiment user input portion 46 corresponds to an up arrow input such as that used to increase or raise a selected value. For example, user input portions 44 and 46 may be used to lower or raise the highest gear available to be obtained by transmission 12 to customize the operating parameters of transmission 12 in certain operating conditions such as driving on a grade, for example.

Segmented input 40 has a shape and orientation that is different from segmented input 30. The relative spacing and orientation of segmented input 40 and segmented input 30 allow a user to distinguish, by touch, the segmented inputs 30 and 40 from each other. Also, the shape of the segmented inputs 30 and 40 allow a user to distinguish, by touch, the corresponding user input portions 34, 36 and 38 of segmented input 30 and user input portions 44 and 46 of segmented input 40.

User input device further includes a selector 48 having a boundary surface 58 which circumscribes the perimeter of selector 48 to define a shape which is generally elliptical. Selector 48 has a selector surface 68 separated from surface 52 of panel 54 by boundary surface 58. Selector 48 is actuable to change a mode in which the transmission 12 operates. For example, selector 48 may be actuated to select a primary or secondary shift schedule mode to enhance performance or fuel economy of the vehicle 14.

User interface 10 further includes a selector 28 which is configured to initialize a diagnostic routine of the controller 13 of the transmission 12. The diagnostic routine is configured to display codes indicative of the status of the transmission 12 on the display 16. The selector 28 includes a boundary surface 29 circumscribing a perimeter of the selector 28. The selector 28 further includes a selector surface 27 separated from a surface 52 of panel 54 of user interface 10 via the boundary surface 29. The boundary surface 29 forms a generally circular shape. The shapes of selectors 28, 30, 40 and 48 allow a user to tactilely distinguish each of the selectors from each of the other selectors.

Referring now to FIG. 3, a generalized cross-section of a user input portion of the user interface 10 is shown. Illustratively, FIG. 3 is a cross-section of user input portion 44 taken along line 3-3 as suggested by FIG. 2. In the illustrative embodiment of FIGS. 2 and 3, user input portion 44 overlies a switch 62 that is actuable by a user to provide an input signal to the controller 13 of transmission 12. Selector surface 56 is spaced vertically below surface 52 of panel 54. Boundary surface 42 connects surface 52 of panel 54 with the surface 56 of user input portion 44. A protective membrane 64 overlies switch 62 and is deflected when a user activates switch 62.

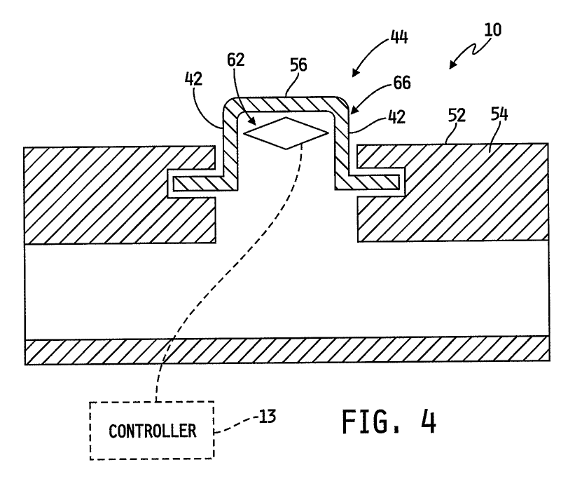

In another embodiment shown in FIG. 4, switch 62 is enclosed in a membrane 66. Membrane 66 is configured such that selector surface 56 is spaced vertically above surface 52 panel 54. While boundary surface 42 connects surface 52 of panel 54 in both the embodiment of FIG. 3 and the embodiment of FIG. 4, in the embodiment of FIG. 3 user input portion 44 is configured such that boundary surface 42 and surface 56 cooperate to form a “well” in which a user's finger must be inserted to activate switch 62. In contrast, in the illustrative embodiment of FIG. 4 boundary surface 42 and selector surface 56 cooperate to define an “island” which extends above surface 52 of panel 54. In either embodiment, a user may tactilely distinguish which of the user input portions 32, 36, 38, 44, 46, 48 the user is engaging when activating an input. Thus, the configuration of user interface 10 is such that a user may become familiar with the location of the various user input portions and thereby operate the transmission 12 without having to look at user interface 10 for extended periods.

It should be understood that in the illustrative embodiments of the present disclosure, each of the user input portions include a switch similar to switch 62 of the illustrative embodiments of FIG. 3 and FIG. 4. The switch 62 provides tactile feedback that the particular switch/user input has been activated. This coupled with the response of the transmission 12 to the input allow a user to operate the transmission 12 without taking their eyes from the road to look at the user interface 10. However, in some embodiments, various combinations of user inputs may be employed with some being raised relative to surface 52 and some being lowered relative to surface 52. Any of a number of combinations of selector shapes and orientations may be employed to allow a user to distinguish each selector 30, 40 and 48 from each other selector 30 40 and 48 and each selector input portion 34, 36, 38, 44 and 46 from each other selector input portion 34, 36, 38, 44 and 46.

Although certain illustrative embodiments have been described in detail above, variations and modifications exist within the scope and spirit of this disclosure as described and as defined in the following claims.

1. A user interface for an automatic transmission, the user interface comprising
a base surface,
a first selector including a first selector surface separated from the base surface by a boundary surface coupled to the first selector surface and coupled to the base surface, the boundary surface shaped such that the boundary surface and the first selector surface cooperate to define a first selector shape, and
a second selector including a second selector surface separated from the base surface by a boundary surface coupled to the second selector surface and coupled to the base surface, the boundary surface shaped such that the boundary surface and the second selector surface cooperate to define a second selector shape different from the first selector shape such that a user may tactilely distinguish the second selector from the first selector.

2. The user interface of claim 1, wherein the first selector includes a first selector input to place the transmission in a reverse mode, a second selector input to place the transmission in a neutral mode, and a third selector input to place the transmission in a drive mode.

3. The user interface of claim 2, wherein each of the selector inputs is configured to provide a tactile feedback to the user when the selector input is activated.

4. The user interface of claim 3, wherein at least one selector input is a discrete momentary switch.

5. The user interface of claim 4, wherein the boundary surface of the first selector extends outwardly away from the base surface.

6. The user interface of claim 4, wherein the boundary surface of the first selector extends inwardly away from the base surface.

7. The user interface of claim 2, wherein the user interface further comprises a display configured to display the operational status of the automatic transmission.

8. The user interface of claim 7, wherein the display includes a first portion configured to display the current gear in which the transmission is operating and a second portion configured to display the maximum gear obtainable in the current mode the transmission is operating.

9. The user interface of claim 8, wherein each of the selector inputs is configured to provide a tactile feedback to the user when the selector input is activated.

10. The user interface of claim 9, wherein each selector input is a discrete momentary switch.

11. A user interface for an automatic transmission, the user interface comprising
a base surface,
a first selector including a first selector surface separated from the base surface by a boundary surface coupled to the first selector surface and coupled to the base surface, the boundary surface shaped such that the boundary surface and the first selector surface cooperate to enclose a plurality of interconnected first selector input portions, each of the plurality of first selector input portions operative to provide a specific input to the automatic transmission different from the other of the plurality of first selector input portions, and
a second selector including a second selector surface separated from the base surface by a boundary surface coupled to the second selector surface and coupled to the base surface, the boundary surface shaped such that the boundary surface and the second selector surface cooperate to enclose a plurality of interconnected second selector input portions, each of the plurality of second selector input portions operative to provide a specific input to the automatic transmission different from the other of the plurality of second selector input portions, the first and second selectors configured such that a user may tactilely distinguish the second selector from the first selector and tactilely distinguish each interconnected selector input from each other interconnected selector input.

12. The user interface of claim 11, wherein the first selector includes a first selector input to place the transmission in a reverse mode, a second selector input to place the transmission in a neutral mode, and a third selector input to place the transmission in a drive mode.

13. The user interface of claim 12, wherein each of the selector inputs is configured to provide a tactile feedback to the user when the selector input is activated.

14. The user interface of claim 13, wherein at least one selector input is a discrete momentary switch.

15. The user interface of claim 14, wherein the boundary surface of the first selector extends outwardly away from the base surface.

16. The user interface of claim 15, wherein the boundary surface of the first selector extends inwardly away from the base surface.

17. The user interface of claim 11, wherein the second selector includes a first input for increasing a selected operational parameter.

18. The user interface of claim 17, wherein the second selector includes a second input for decreasing a selected operational parameter.

19. The user interface of claim 18, wherein the boundary surface of the second selector extends inwardly away from the base surface.

20. The user interface of claim 19, wherein the boundary surface of the second selector extends outwardly away from the base surface.
